(19) United States
(12) Patent Application Publication
(10) Pub. No.: US 2019/0332976 A1
(43) Pub. Date: Oct. 31, 2019

(54) Method of Automatically Requesting Hospitality Preferences

(71) Applicant: Claudio Bono, Cupertino, CA (US)

(72) Inventor: Claudio Bono, Cupertino, CA (US)

(21) Appl. No.: 16/183,492

(22) Filed: Nov. 7, 2018

Related U.S. Application Data
(60) Provisional application No. 62/663,489, filed on Apr. 27, 2018.

(51) Int. Cl. G06Q 10/02; G06Q 30/02

(52) U.S. Cl. CPC G06Q 10/025; H04L 67/20; G06Q 30/0226

(57) ABSTRACT

A method of automatically requesting hospitality preferences requires at least one remote server, a traveler personal computing (PC) device, and a hospitality host PC device. The method begins by prompting a traveler account to upload at least one upcoming trip and an option wish list through the traveler PC device. A traveler profile is generated for the traveler account with the remote server which includes the upcoming trip and the option wish list. The hospitality host identifier is compared to each of the plurality of hospitality host accounts with the remote server. The traveler account is prompted to select a preferred hospitality option with the traveler PC device. The option wish list is compared to the plurality of hospitality options for the matching host with remote server. The at least one matching preference is appended into the set of trip details with the remote server.

The current application claims priority to U.S. provisional application Ser. No. 62/663,489 filed on Apr. 27, 2018.

### FIELD OF THE INVENTION

The present invention generally relates to booking trips. More specifically, the present invention allows a user to automatically request hospitality preferences.

### BACKGROUND OF THE INVENTION

Traveling is can be a stressful event that requires multitasking. With the aid of smartphones and apps however, travelers have quicker access to airlines and hotels, as well as their own individual trip details. Competition among travel agencies, such as airlines and hotels, is high and dependent on the satisfaction of travelers. In order to increase customer satisfaction, travel agencies must not only simplify the stress of traveling but enhance the traveling experience.

It is therefore the objective of the present invention to allow travelers to make a request whenever he or she feels like doing so, and the request is automatically and immediately delivered to the travel agency. The present invention allows a traveler to customize an upcoming trip to his or her liking. No matter how small a detail, the traveler may customize the details of his or her trip. For example, the traveler may request a hotel room away from the elevator or request a gluten-free meal for his or her seat on the plane. The travel agency is able to prepare and tend to the request before the trip and ease the traveling experience even more.

### BRIEF DESCRIPTION OF THE DRAWINGS

FIG. 1 is a schematic view of the wireless communication between at least one server and a plurality of corresponding portable computing devices of the present invention.

FIG. 2 is a flowchart illustrating the overall process from Step A to Step E for the present invention.

FIG. 3 is a flowchart illustrating the overall process from Step F to Step H for the present invention.

FIG. 4 is a flowchart illustrating the process of designating a new set of trip details as a set of trip details with a remote server for the present invention.

FIG. 5 is a flowchart illustrating the process of relaying the set of trip details from a traveler portable computing (PC) device, with the remote server, and to a hospitality host PC device for the present invention.

FIG. 6 is a flowchart illustrating the process of displaying a receipt notification to the traveler PC device for the present invention.

FIG. 7 is a flowchart illustrating the process of generating a hospitality host account with the remote server, wherein a hospitality account includes a set of host identification information for the present invention.

FIG. 8 is a flowchart illustrating the process of relaying the set of trip details to the hospitality PC device for a matching hospitality host account with the remote server for the present invention.

FIG. 9 is a flowchart illustrating the process of integrating a rating score into a summarization information for the hospitality host account with the remote server for the present invention.

FIG. 10 is a flowchart illustrating the process of designating a new plurality of hospitality options as a plurality of hospitality options with the remote server for the present invention.

FIG. 11 is a flowchart illustrating the process of disabling the traveler account from selecting a preferred hospitality option during step (F) with the remote server, if the time window is less than the cutoff threshold for the present invention.

### DETAIL DESCRIPTIONS OF THE INVENTION

All illustrations of the drawings are for the purpose of describing selected versions of the present invention and are not intended to limit the scope of the present invention.

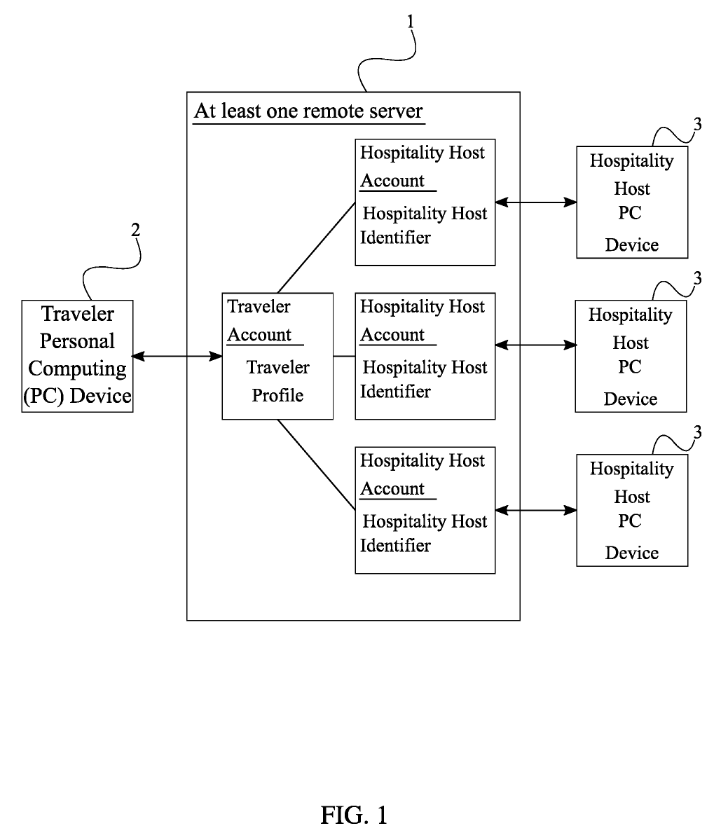

The present invention is a method of automatically requesting hospitality preferences. The present invention is used to automatically request hospitality preferences immediately in order to a hospitality host, such as a hotel or airline, to process the hospitality preference and tend to the preference immediately. More specifically, the hospitality host may address the hospitality preference of a traveler before the arrival of the traveler. The present invention provides travelers direct contact with hospitality hosts associated with upcoming trips and recurrent hospitality hosts associated with past trips. Thus, the physical system used to implement the method of the present invention includes at least one remote server 1, a traveler personal computing (PC) device 2, and a hospitality host PC device 3, as seen in FIG. 1. The at least one remote server 1 manages a traveler account, a plurality of hospitality host accounts, and a plurality of hospitality options. The traveler account is associated to the traveler PC device 2 (Step A). The traveler PC device 2 communicates with the plurality of hospitality host PC devices 3 through the at least one remote server 1. Each hospitality host account includes a plurality of hospitality options. Moreover, each hospitality host account is associated to a hospitality host PC device 3 (Step B). The plurality of hospitality options are the amenities and services offered by a corresponding hospitality host account. Such examples of hospitality options include, but are not limited to, welcome fruit, welcome drinks, airline meals, hotel pillows, airline pillows and blankets, non-smoking rooms, and so on. More specifically, if the traveler account wishes to change a meal flight, the user may do so immediately. For example, the traveler account may have a gluten free meal associated with the upcoming trip. The traveler account simply selects a more enjoyable, but less healthy option of the plurality of hospitality options at any point in time. Not only is the meal flight updated with the hospitality host account. The gluten-free meal, however, is still associated with recurring upcoming trips and if the traveler account wishes to have more enjoyable, but less healthy option, again, the traveler account must update a specific upcoming trip. The wish list and the preferred hospitality option are compared to each hospitality option with the remote server 1 in order to identify at least one matching preference from the plurality of hospitality options. The traveler PC device 2 is preferably a smart device such as a smart phone or tablet that a traveler can access immediately and from a variety of locations. The hospitality host PC device 3 may be a desktop computer or a smart device. In an alternate embodiment of the present invention, the hospitality host PC device 3 is a standard desktop computer.

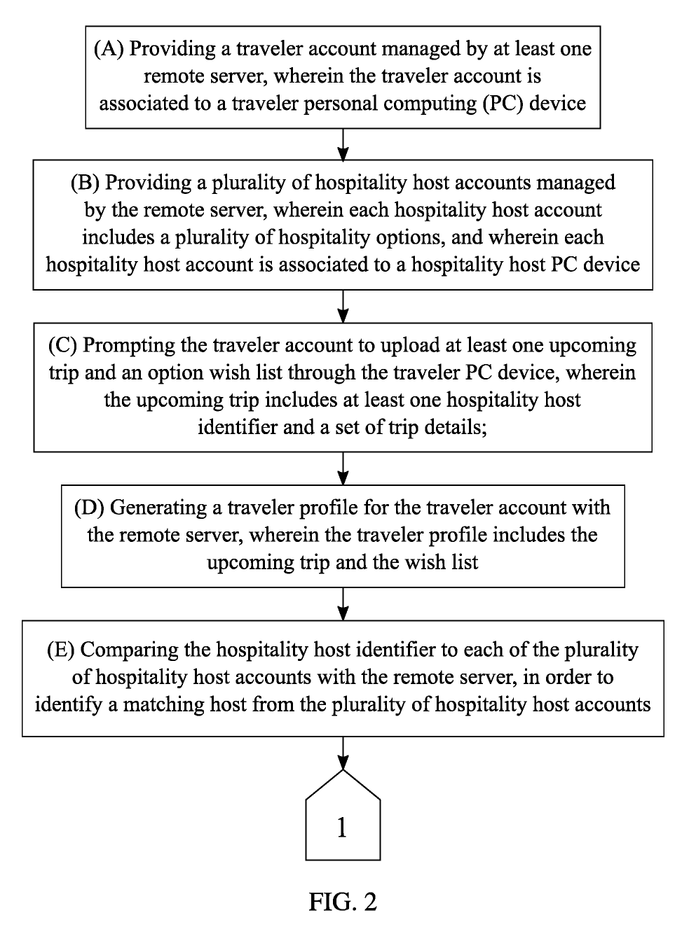

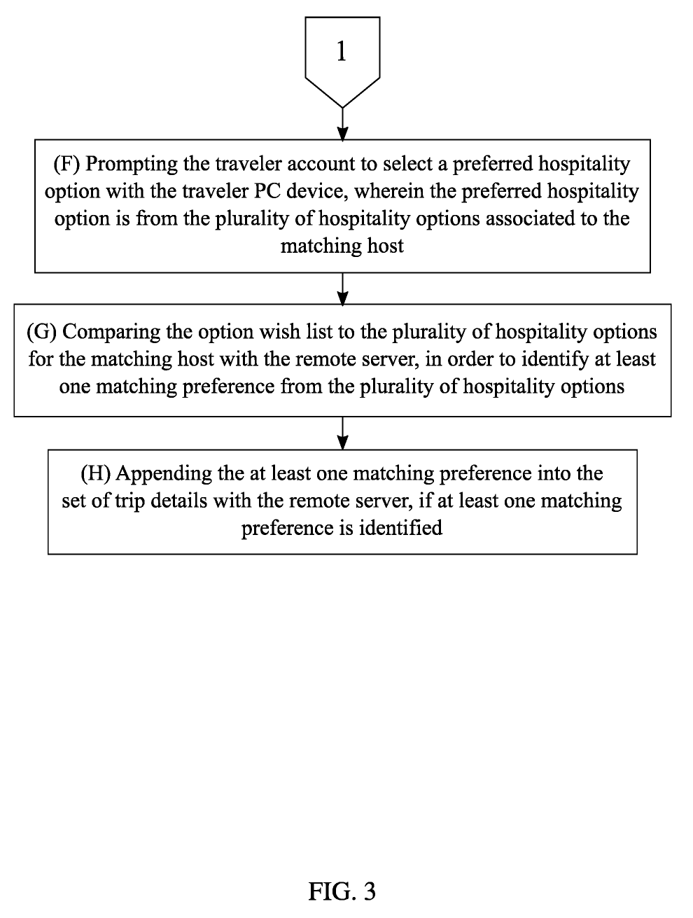

The overall process for the present invention includes the following steps that are implemented with the at least one remote server 1, the traveler PC device 2, and the hospitality host PC device 3. As seen in FIG. 2, the overall process begins by prompting the traveler account to upload an upcoming trip and an option wish list through the traveler PC device 2, as shown in FIG. 2. The upcoming trip includes at least one hospitality host identifier and a set of trip details (Step C). The upcoming trip is a booked trip of the traveler account with a hotel name or airline name as the at least one hospitality host identifier and a date, a time, and a location as the set of trip details. The set of trip details may include more specific information that further specifies the timeline and destinations of the upcoming trip. More specifically, the upcoming trip is associated with at least one airline, at least one hotel or similar lodging, or both. The option wish list includes common preferences of the traveler account associated with certain airlines and hotels. In order to directly communicate with a hospitality host account of the plurality of hospitality of host accounts, a traveler profile is generated for the traveler account with the remote server 1. The traveler profile includes the upcoming trip and the option wish list (Step D). The traveler account provides the necessary information to the plurality of hospitality host accounts regarding the traveler account. The traveler account also allows the plurality of hospitality host accounts to associate each hospitality option with the corresponding traveler account, and consequently the corresponding upcoming trip. The hospitality host identifier is compared to each of the plurality of host accounts with the remote server 1, in order to identify a matching host from the plurality of hospitality host accounts (Step E). As seen in FIG. 3, specific requests are made by the traveler account as the traveler account is prompted to select a preferred hospitality option with the traveler PC device 2, wherein the preferred hospitality option is from the plurality of hospitality options associated to the matching host (Step F). The option wish list is compared to the plurality of hospitality options for the matching host with the remote server 1, in order to identify at least one matching preference from the plurality of hospitality option (Step G). The frequent requests of the traveler account are therefore automatically requested with the present invention. The at least one matching preference is appended into the set of trip details with the remote server 1, if at least one matching preference is identified (Step H), effectively communicating the specific requests of the traveler account with the hospitality host account. The specific requests of the traveler account are also recorded for the upcoming trip with the present invention.

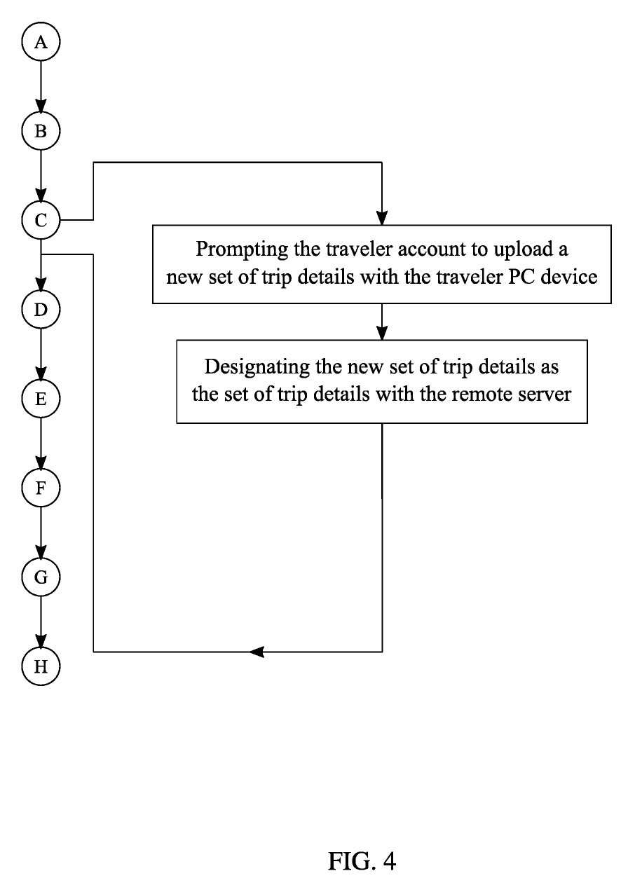

In order to associate an upcoming trip that had already been booked or book an upcoming trip through the traveler account and with the traveler PC device 2, the traveler account is prompted to upload a new set of trip details the traveler PC device 2, as seen in FIG. 4. The new set of trip details includes dates, times, locations of arrival and departure, and a variety of other specifics regarding the upcoming trip. The new set of trip details is designated as the set of trip details with the remote server 1, allowing the corresponding hospitality host account to access to the set of trip details. The set of trip details is displayed with the hospitality host PC device 3, allowing the hospitality host account to view the new set of trip details and accommodate the option wish list and the selected preferred hospitality options of the traveler account promptly.

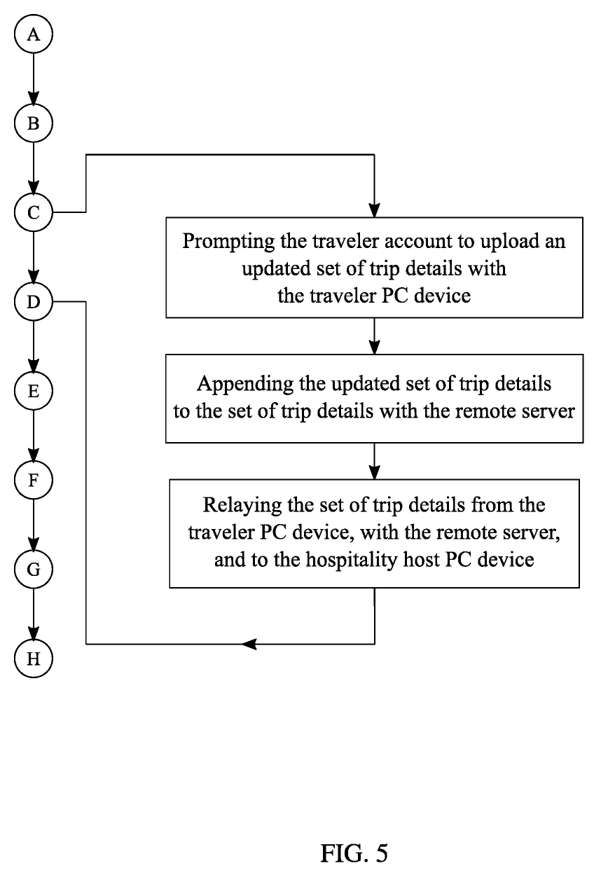

In the event the set of trip details changes due to the changes in schedule of the traveler account or for any other reason, the traveler account is prompted to upload an updated set of trip details with the traveler PC device 2, seen in FIG. 5. The updated set of trip details may include a new date, a new time, a new location, and so on. The new set of trip details is overridden with the updated set of trip details with the remote server 1, as the updated set of trip details is appended to the set of trip details with the remote server 1. The correct information of the upcoming trip is associated with the upcoming trip of the traveler account. The set of trip details is then relayed from the traveler PC device 2, with the remote server 1, and to the hospitality host PC device 3. The set of trip details is displayed with the hospitality host PC device 3. This allows the hospitality host account to view the updated set of trip details and adjust the tending of the wish list and the preferred hospitality options accordingly. Any preferred hospitality options initially selected for the upcoming trip is preferably resent to the hospitality host account with the remote server 1.

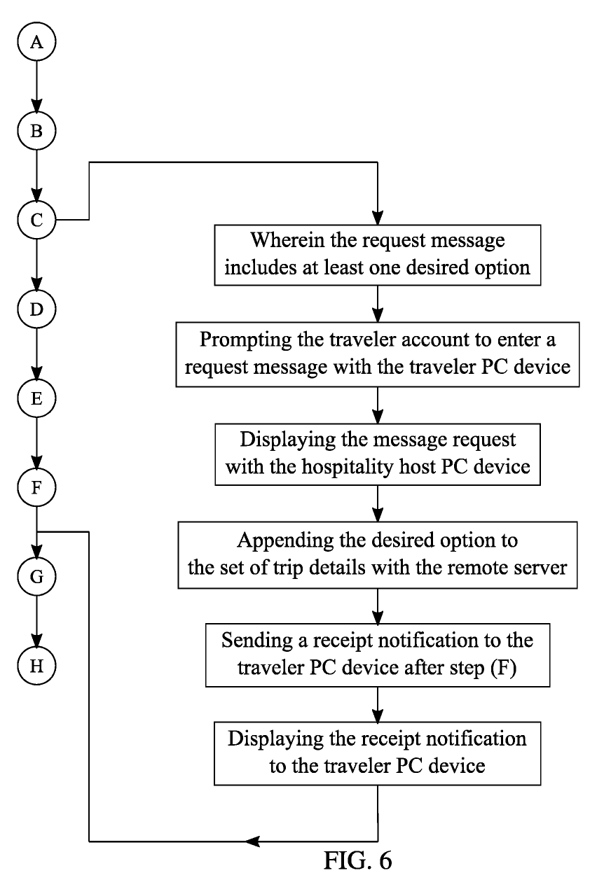

If a specific hospitality option of the traveler account is not part of the plurality of hospitality options, the traveler account may directly deliver the specific hospitality option to the hospitality host account. As seen in FIG. 6, the traveler account is prompted to enter a message request with the traveler PC device 2, wherein the request message includes at least one desired option. The message request is preferably text that describes in detail the specific hospitality option desired by the traveler account. The message request is displayed with the hospitality host PC device 3. The hospitality host account is able to view the message request with the hospitality host PC device 3. The desired option is appended to the set of trip details with the remote server 1 in order to associate the message request with the upcoming trip. The hospitality host account is notified of the desired option with the message request and is able to accommodate the specific hospitality option. If the hospitality account is not able to tend to the desired option, the hospitality account may directly contact the traveler account with the hospitality host PC device 3.

Once the hospitality host account views the desired option with the message request, the traveler account is notified of the delivery and viewing of the desired option and the message request, as seen in FIG. 6. More specifically, a receipt notification is sent to the traveler PC device 2 after step (F). The receipt notification is displayed to the traveler PC device in order for the hospitality host account to acknowledge the successful delivery and viewing of the desired option with the message request.

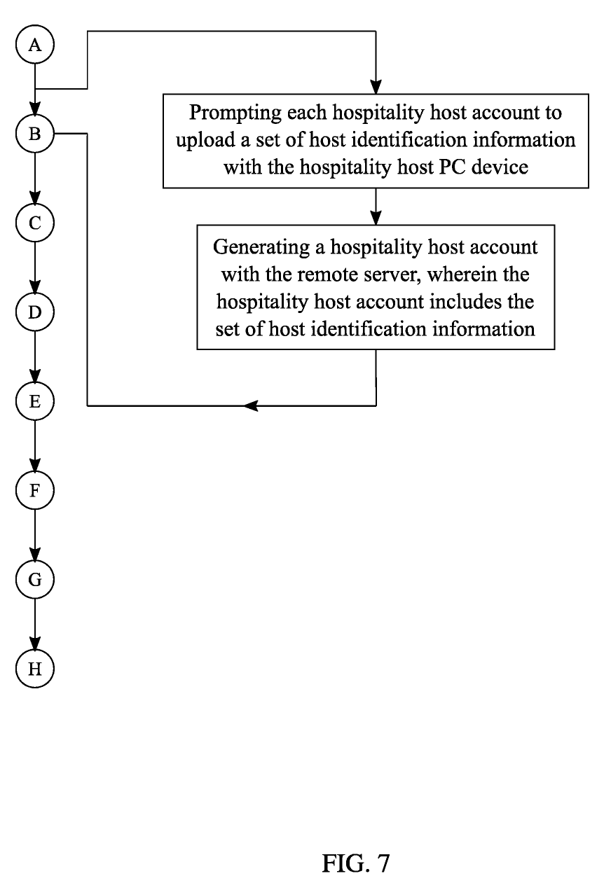

In order for the traveler account to effectively select a desired hospitality host account, each hospitality host account is prompted to upload a set of host identification information with the hospitality host PC device 3, as seen in FIG. 7. The set of host identification information may include, but is not limited to, name, location, contact information, photos, description, ratings, official website link, and so on. The set of host identification information differentiates each hospitality host account from each other. This differentiation may aid a traveler account make an informed selection while booking an upcoming trip with the present invention, rather than uploading the set of trip details of an existing upcoming trip. A hospitality host account is generated with the remote server 1, wherein the hospitality host account includes the set of host identification information. More specifically, the set of host identification information is associated with the hospitality host. The hospitality account is then viewable by traveler accounts with the corresponding traveler PC devices 2.

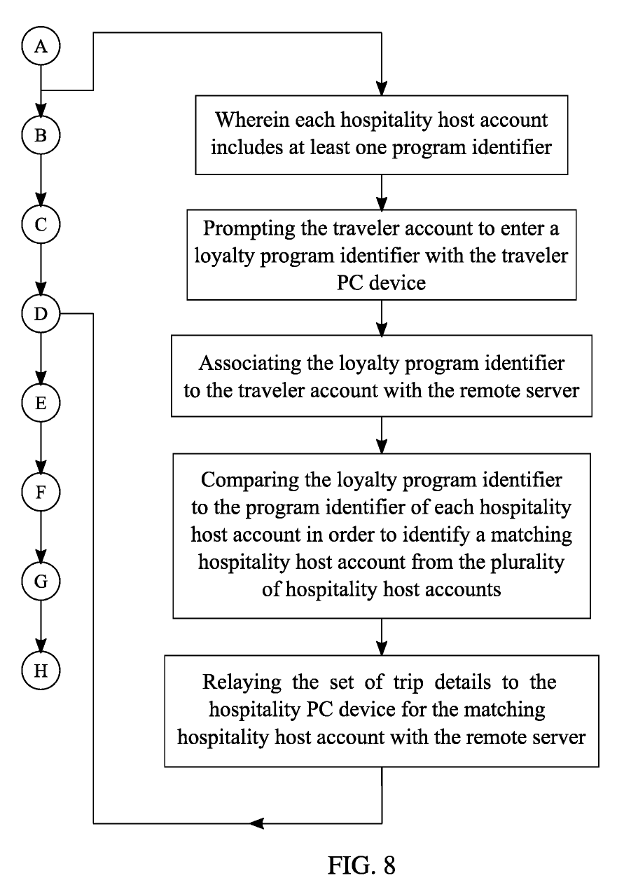

Whether the upcoming trip is already booked and uploaded into the traveler account or the upcoming trip is booked with the present invention, the upcoming trip may be recognized by any corresponding loyalty programs. In order to apply the upcoming trip to the corresponding loyalty program, each hospitality host account includes at least one program identifier, as seen in FIG. 8. The traveler account is prompted to enter a loyalty program identifier with the traveler PC device 2. The loyalty program identifier registers any travel or lodging points that may be accounted for by the hospitality host account by repeated traveler accounts. The loyalty program identifier is associated to the traveler account with the remote server 1. Points applicable towards the loyalty program of the traveler account may be accounted for according to the set of trip details which correspond with the upcoming trip. The loyalty program identifier is compared to the program identifier of each hospitality host account in order to identify a matching hospitality host account from the plurality of hospitality host accounts. The set of trip details is relayed to the hospitality host account from the plurality of hospitality host accounts for the hospitality host account to keep track of recurring activity of each traveler account.

The traveler account is able to view a specific hospitality host account as the traveler account is prompted to upload automated search criteria with the traveler PC device 2. The automated search criteria is relayed from the traveler PC device 2 to the remote server 1. The automated search criteria is then compared to each hospitality host account in order to identify a matching hospitality host account from the plurality of host accounts. The matching hospitality host account is displayed through the traveler PC device 2, wherein the matching hospitality host account is from the plurality of hospitality host accounts. The traveler account may view the hospitality host profile and select the hospitality host account.

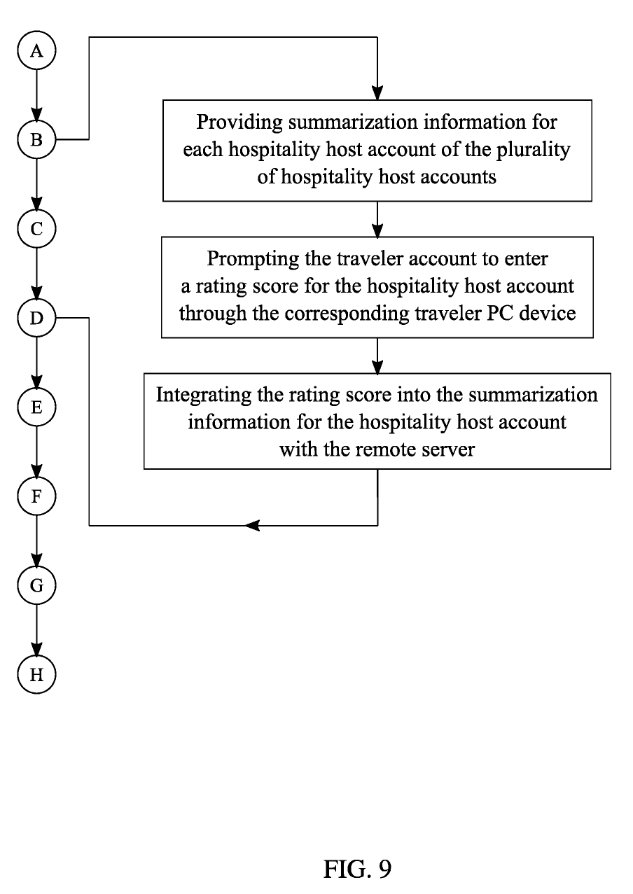

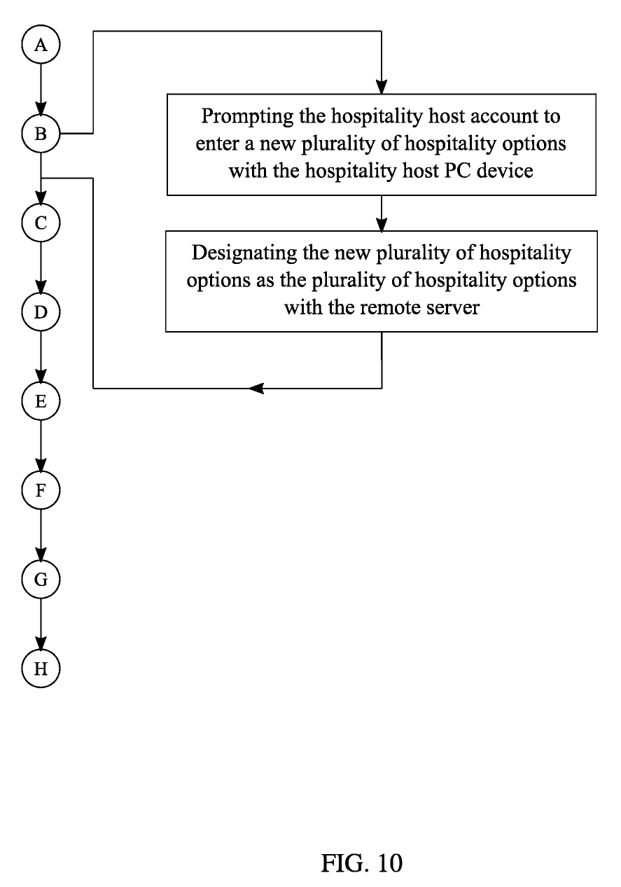

Whether a hospitality account is already associated with an upcoming trip or is viewed through a search, the traveler account may rate at least one hospitality host account of the plurality of hospitality host accounts, as seen in FIG. 9. Summarization information is provided for each hospitality host account of the plurality of host accounts. The summarization information includes, but is not limited to, an address, a telephone number, a description of the corresponding hospitality host account, and a list of prices. The traveler account is prompted to enter a rating score for the hospitality host account through the corresponding traveler PC device 2. The rating score provides other traveler accounts with a more reliable source of the state and quality of the hospitality host account. The rating score is integrated into the summarization information for the hospitality host account with the remote server 1. The integration of the rating score applies the rating score to an overall rating of the hospitality host account from other traveler accounts. The overall rating of the hospitality host account is viewable by the traveler account. As each hospitality host account of the plurality of hospitality host accounts provide individual accommodations and varying services, the plurality of hospitality options is unique to each hospitality host account. The hospitality host account is able to customize the plurality of hospitality options as the hospitality host account is prompted to enter a new plurality of hospitality options with the hospitality host PC device 3, seen in FIG. 10. The new plurality of hospitality options is designated as the plurality of hospitality options with the remote server 1. The traveler account is able to select a preferred hospitality option from an accurate and up-to-date plurality of hospitality options.

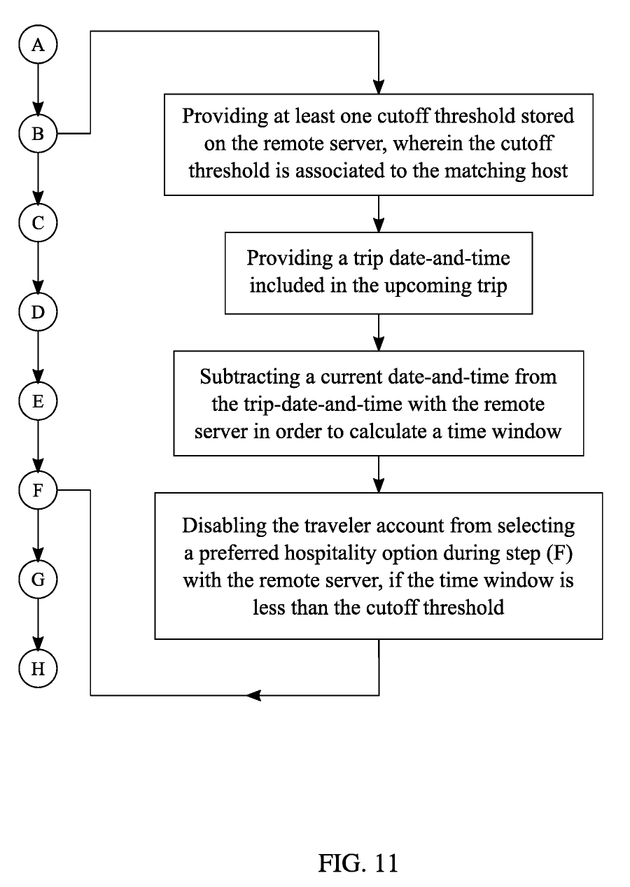

In order for the plurality of hospitality host accounts to effectively process and properly execute the preferred hospitality options of the traveler account and other traveler accounts, at least one cutoff threshold is provided and stored on the remote server 1, wherein the cutoff threshold is associated to the matching host, seen in FIG. 11. Moreover, a trip date-and-time is provided and included in the upcoming trip. A current date-and-time is subtracted from the trip-date-and-time with the remote server 1 in order to calculate a time window. In order to prevent the traveler account from requesting or altering existing preferred hospitality options, the traveler account is disabled from selecting a preferred hospitality option during step (F) with the remote server 1, if the time window is less than the cutoff threshold.

It is understood that for both the traveler account and each of the hospitality host accounts that login information is requested to and uploaded through the remote server 1. Such login information includes username, email, password, and any verification information necessary to effectively identify and protect the traveler account and each hospitality account.

Although the invention has been explained in relation to its preferred embodiment, it is to be understood that many other possible modifications and variations can be made without departing from the spirit and scope of the invention as hereinafter claimed.

What is claimed is:

1. A method of automatically requesting hospitality preferences, the method comprises the steps of:
(A) providing a traveler account managed by at least one remote server, wherein the traveler account is associated to a traveler personal computing (PC) device;
(B) providing a plurality of hospitality host accounts managed by the remote server, wherein each hospitality host account includes a plurality of hospitality options, and wherein each hospitality host account is associated to a hospitality host PC device;
(C) prompting the traveler account to upload at least one upcoming trip and an option wish list through the traveler PC device, wherein the upcoming trip includes at least one hospitality host identifier and a set of trip details;
(D) generating a traveler profile for the traveler account with the remote server, wherein the traveler profile includes the upcoming trip and the wish list;
(E) comparing the hospitality host identifier to each of the plurality of hospitality host accounts with the remote server, in order to identify a matching host from the plurality of hospitality host accounts;
(F) prompting the traveler account to select a preferred hospitality option with the traveler PC device, wherein the preferred hospitality option is from the plurality of hospitality options associated to the matching host;
(G) comparing the option wish list to the plurality of hospitality options for the matching host with the remote server, in order to identify at least one matching preference from the plurality of hospitality options; and,
(H) appending the at least one matching preference into the set of trip details with the remote server, if at least one matching preference is identified.

2. The method of automatically requesting hospitality preferences, the method as claimed in 1 comprises the steps of:
prompting the traveler account to upload a new set of trip details with the traveler PC device; and,
designating the new set of trip details as the set of trip details with the remote server.

3. The method of automatically requesting hospitality preferences, the method as claimed in 1 comprises the steps of:
prompting the traveler account to upload an updated set of trip details with the traveler PC device;
appending the updated set of trip details to the set of trip details with the remote server; and,
relaying the set of trip details from the traveler PC device, with the remote server, and to the hospitality host PC device.

4. The method of automatically requesting hospitality preferences, the method as claimed in 1 comprises the steps of:
prompting the traveler account to enter a request message with the traveler PC device, wherein the request message includes at least one desired option;
displaying the message request with the hospitality host PC device; and,
appending the desired option to the set of trip details with the remote server.

5. The method of automatically requesting hospitality preferences, the method as claimed in 4 comprises the steps of:
sending a receipt notification to the traveler PC device after step (F); and,
displaying the receipt notification to the traveler PC device.

6. The method of automatically requesting hospitality preferences, the method as claimed in 1 comprises the steps of:
prompting each hospitality host account to upload a set of host identification information with the hospitality host PC device; and,
generating a hospitality host account with the remote server, wherein the hospitality host account includes the set of host identification information.

7. The method of automatically requesting hospitality preferences, the method as claimed in 1 comprises the steps of:
wherein each hospitality host account includes at least one program identifier;
prompting the traveler account to enter a loyalty program identifier with the traveler PC device;
associating the loyalty program identifier to the traveler account with the remote server;
comparing the loyalty program identifier to the program identifier of each hospitality host account in order to identify a matching hospitality host account from the plurality of hospitality host accounts; and,
relaying the set of trip details to the hospitality PC device for the matching hospitality host account with the remote server.

8. The method of automatically requesting hospitality preferences, the method as claimed in 1 comprises the steps of:
providing summarization information for each hospitality host account of the plurality of hospitality host accounts;
prompting the traveler account to enter a rating score for the hospitality host account through the corresponding traveler PC device; and,
integrating the rating score into the summarization information for the hospitality host account with the remote server.

9. The method of automatically requesting hospitality preferences, the method as claimed in 1 comprises the steps of:
prompting the hospitality host account to enter a new plurality of hospitality options with the hospitality host PC device; and,
designating the new plurality of hospitality options as the plurality of hospitality options with the remote server.

10. The method of automatically requesting hospitality preferences, the method as claimed in 1 comprises the steps of:
providing at least one cutoff threshold stored on the remote server, wherein the cutoff threshold is associated to the matching host;
providing a trip date-and-time included in the upcoming trip;
subtracting a current date-and-time from the trip-date-and-time with the remote server in order to calculate a time window; and,
disabling the traveler account from selecting a preferred hospitality option during step (F) with the remote server, if the time window is less than the cutoff threshold.
